(19) United States
(12) Patent Application Publication
(10) Pub. No.: US 2024/0405376 A1
(43) Pub. Date: Dec. 5, 2024

(54) BATTERY MODULE

(71) Applicant: INTERPLEX INDUSTRIES, INC., East Providence, RI (US)

(72) Inventor: Vu Phan, Garden Grove, CA (US)

(21) Appl. No.: 18/699,176

(22) PCT Filed: Oct. 11, 2022
(86) PCT No.: PCT/US2022/046248

§ 371 Date: Apr. 5, 2024

Related U.S. Application Data
(60) Provisional application No. 63/254,187, filed on Oct. 11, 2021.

(51) Int. Cl. H01M 50/503; H01M 50/213; H01M 50/296; H01M 50/509; H01M 50/522

(52) U.S. Cl. CPC H01M 50/503; H01M 50/213; H01M 50/296; H01M 50/509; H01M 50/522

(57) ABSTRACT

A battery module having a plurality of battery cells arranged in groups. which are located in two or more module sections. A plurality of monolithic interconnect structures is connected to the battery cells. The interconnect structures are connected to the battery cells to have electrical current flow in a first direction in one of the module sections and flow in an opposing second direction in another one of the module sections. The interconnect structures are arranged in a single layer.

### CROSS-REFERENCE TO RELATED APPLICATION(S)

This application claims the benefit of priority under 35 U.S.C. § 119(e) to U.S. Provisional Patent Application No.: 63/254, 187 filed on 11 Oct. 2021, which is herein incorporated by reference.

### TECHNICAL FIELD

The present disclosure relates to a battery module and more particularly to a battery module with a battery cell interconnect system.

### BACKGROUND

It is known to have a battery module that includes a plurality of battery cells mounted in a housing and connected together so as to have a predetermined capacity and voltage output. Such a battery module is widely used as a power source for vehicles and various types of other devices and equipment. A plurality of the battery modules is often connected together to form a battery system, also having a predetermined capacity and voltage output. In a particular battery module, the battery cells may be connected together in parallel and/or in series to provide a desired capacity and voltage output. Often, the battery cells are arranged closely together and are individually fused to avoid damage or excessive heating of adjacent battery cells and/or other components.

A battery module having the construction described above is conventionally difficult to manufacture and typically requires complicated procedures and specialized machinery. As such, there is a need for a battery module having an improved interconnect system that makes the manufacture of the battery module simpler and less expensive.

### SUMMARY

A battery module is disclosed having a plurality of battery cells. Each of the battery cells Includes a positive terminal and a negative terminal. The battery cells are arranged in groups, which are located in at least two module sections. A plurality of monolithic interconnect structures is connected to the battery cells. The interconnect structures are formed from a conductive metal and include a plurality of tabs connected to the positive terminals of the battery cells and a plurality of negative tabs connected to the negative terminals of the battery cells. The interconnect structures are connected to the battery cells to have electrical current flow in a first direction in one of the module sections and flow in an opposing second direction in another one of the module sections. The interconnect structures are arranged in a single layer.

Each group of battery cells may include four or more battery cells that are connected together in parallel by a pair of the interconnect structures, and the groups of battery cells may be connected in series by the interconnect structures.

### BRIEF DESCRIPTION OF THE DRAWINGS

The features, aspects, and advantages of the present invention will become better understood with regard to the following description, appended claims, and accompanying drawings where:

FIG. 1 shows a perspective view of a battery cell of a battery module;

FIG. 2 shows a top perspective view of a first battery module constructed in accordance with a first embodiment of the disclosure;

FIG. 3 shows a top plan view of the first battery module of FIG. 2;

FIG. 4 shows a top plan view of the first battery module of FIG. 2 with three battery groups removed for better illustration;

FIG. 5 shows a top plan view of the first battery module of FIG. 2 with four other battery groups removed for better illustration;

FIG. 6 shows a top plan view of a second battery module constructed in accordance with a second embodiment of the disclosure;

FIG. 7 shows a top plan view of a third battery module constructed in accordance with a third embodiment of the disclosure;

FIG. 8 shows a top plan view of a fourth battery module constructed in accordance with a fourth embodiment of the disclosure;

FIG. 9 shows a top plan view of a fifth battery module constructed in accordance with a fifth embodiment of the disclosure;

FIG. 10 shows a top plan view of the fifth battery module of FIG. 9 with seven battery groups removed for better illustration;

FIG. 11 shows a top plan view of the fifth battery module of FIG. 9 with seven other battery groups removed for better illustration;

FIG. 12 shows a top perspective view of a sixth battery module constructed in accordance with a sixth embodiment of the disclosure;

FIG. 13 shows a top plan view of the sixth battery module of FIG. 12 with three battery groups removed for better illustration;

FIG. 14 shows a top plan view of the sixth battery module of FIG. 12 with four other battery groups removed for better illustration;

FIG. 15 shows a top perspective view of a housing which may be used in one or more of the first through sixth battery modules; and

FIG. 16 shows a top plan view of the sixth battery module having the housing of FIG. 15, wherein a lid of the housing and other components have been removed for better illustration.

### DETAILED DESCRIPTION OF ILLUSTRATIVE EMBODIMENTS

It should be noted that in the detailed descriptions that follow, identical components have the same reference numerals, regardless of whether they are shown in different embodiments of the present disclosure. It should also be noted that for purposes of clarity and conciseness, the drawings may not necessarily be to scale and certain features of the disclosure may be shown in somewhat schematic form.

Spatially relative terms, such as “top”, “bottom”, “lower”, “above”, “upper”, and the like, are used herein merely for ease of description to describe one element or feature's relationship to another element(s) or feature(s) as they are illustrated in (a) drawing figure(s) being referred to. It will be understood that the spatially relative terms are not meant to be limiting and are intended to encompass different orientations of the device in use or operation in addition to the orientation depicted in the drawings.

The present disclosure is directed to a battery module, which may be used in a battery system for a vehicle, such as an electric vehicle (“EV”) or a hybrid electric vehicle (“HEV”). The battery module generally includes a housing, a plurality of battery cells 14 and a battery interconnect system (BIS). The BIS includes positive and negative terminals that may be used to connect to other battery modules to form circuits of battery modules in which the battery modules are connected in series and/or in parallel.

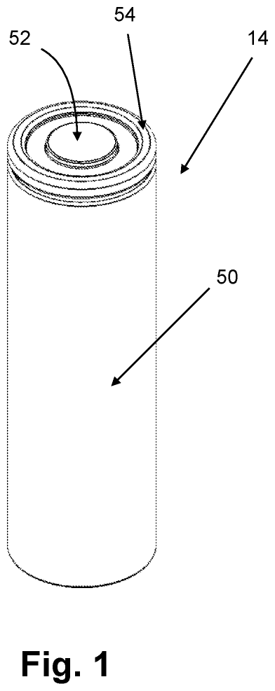

Referring now to FIG. 1, the battery cells 14 may be rechargeable lithium ion (LI-ION) batteries or other type of rechargeable battery. An example of a rechargeable LI-ION battery that may be used is an 18650 type LI-ION battery, having a cylindrical shape with a diameter of about 18 mm and a length of about 65 mm. Alternatively, other rechargeable battery form factors and/or chemistries may be used. In or more embodiments, including the ones shown, each battery cell 14 has a cylindrical case 50 with first and second ends. A center positive terminal 52 and a surrounding annular negative terminal 54 are located at the first end.

In the embodiments of the battery module described below, the battery cells 14 are arranged in a matrix comprising rows and columns. The matrix has ten or more rows and ten or more columns of battery cells 14. Each row and column of battery cells 14 may generally be referred to as a linear series of two or more battery cells 14. The rows extend horizontally, which is the longitudinal orientation of the terminals (e.g. 100, 102), and the columns extend vertically. Adjacent columns may be offset in the vertical direction, while adjacent rows may be offset in the horizontal direction. The battery cells 14 in each embodiment of the battery module are arranged in two or more module sections in which the direction of electric current flow in one module section is opposite to the direction of current flow in an adjacent module section. The module sections are arranged side-by-side or mostly side-by-side. Each module section includes a plurality of groups of battery cells 14. Each group of battery cells 14 includes a plurality of battery cells 14 in a plurality of rows and a plurality of battery cells 14 in a plurality of columns. In each module section, the groups are arranged vertically in a serial manner.

The BIS generally includes a plurality of interconnect structures that overlay the battery cells 14 and are arranged in a single layer, i.e., are not arranged in multiple overlapping layers and are at least mostly coplanar with each other. Each interconnect structure is unitary or monolithic and is formed (such as by stamping) from a conductive metal, such as copper or a copper alloy. In addition, each interconnect structure has an irregular shape with positive tabs 56 and/or negative tabs 57 joined to and extending from arms 55. The interconnect structures are connected (such as through laser welding) to the battery cells 14 to form a desired circuit arrangement for the first battery module 10. The circuit arrangement may have the battery cells 14 connected together in series, parallel and/or combinations thereof. For example, in each of the embodiments described below, the BIS forms a circuit arrangement in which a plurality of the groups of battery cells 14 are electrically connected in series, wherein in each group, the battery cells 14 are electrically connected in parallel. In each of the embodiments, a first one of the interconnect structures has only positive tabs connected to positive terminals of battery cells 14; a final one of the interconnect structures has only negative tabs connected to negative terminals of battery cells; and other ones of the interconnect structures each have positive tabs connected to positive terminals of battery cells 14 and negative tabs connected to negative terminals of battery cells 14. The BIS connects to the positive and negative terminals of the battery module. Each of the positive and negative terminals may be integral to an interconnect structure or may be separate from, but connected to, an interconnect structure, such as by a cable or a bus bar.

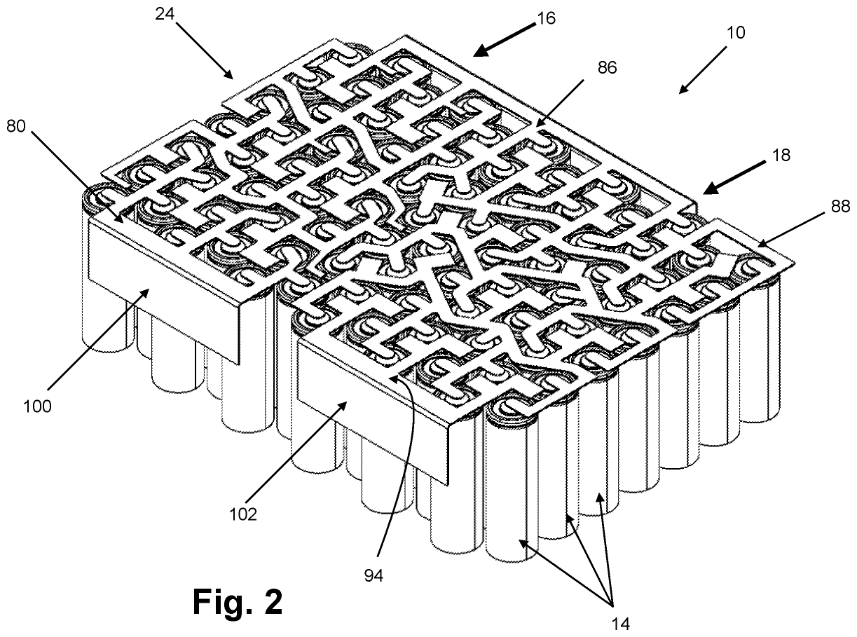

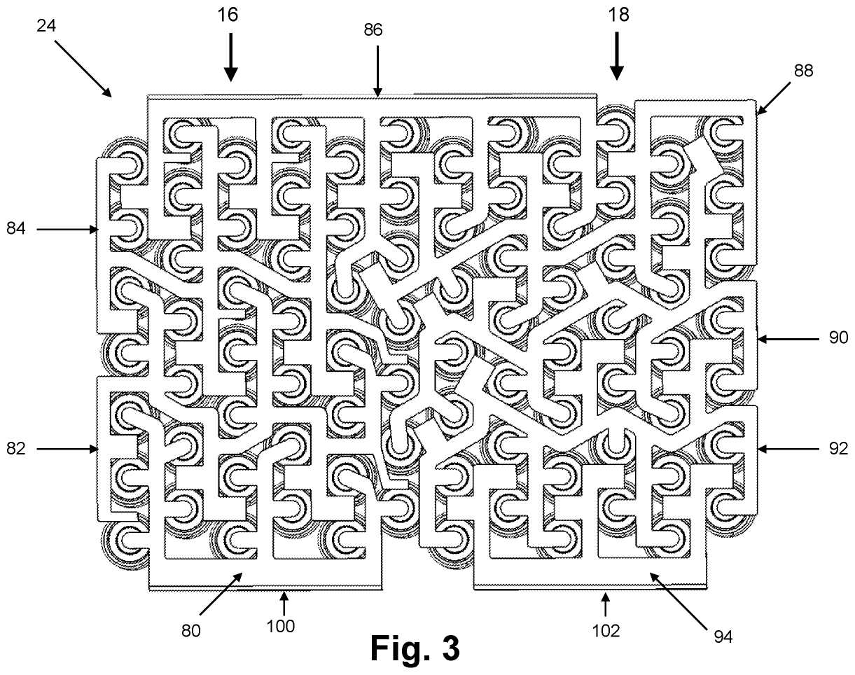

FIGS. 2 and 3 show a first embodiment of a battery module (denoted by the reference numeral 10) having a matrix of battery cells 14 arranged in fourteen rows and twelve columns, i.e., a 14×12 matrix. There are a total of eighty-four battery cells 14, with six battery cells 14 in each row and seven battery cells 14 in each column. There are seven groups of battery cells 14, with twelve battery cells 14 in each group. The first through seventh battery groups have the reference numbers 64, 66, 68, 70, 72, 74, 76, respectively. The first, second and third battery groups 64, 66, 68 are arranged in a first module section 16, while the fourth, fifth, sixth and seventh battery groups 70, 72, 74 and 76 are arranged in a second module section 18. The first and second module sections 16, 18 are adjacent to each other and are disposed side-by-side in the horizontal direction. As will described more fully below, the direction of electric current flow in the first module section 16 is opposite to the direction of current flow in the second module section 18.

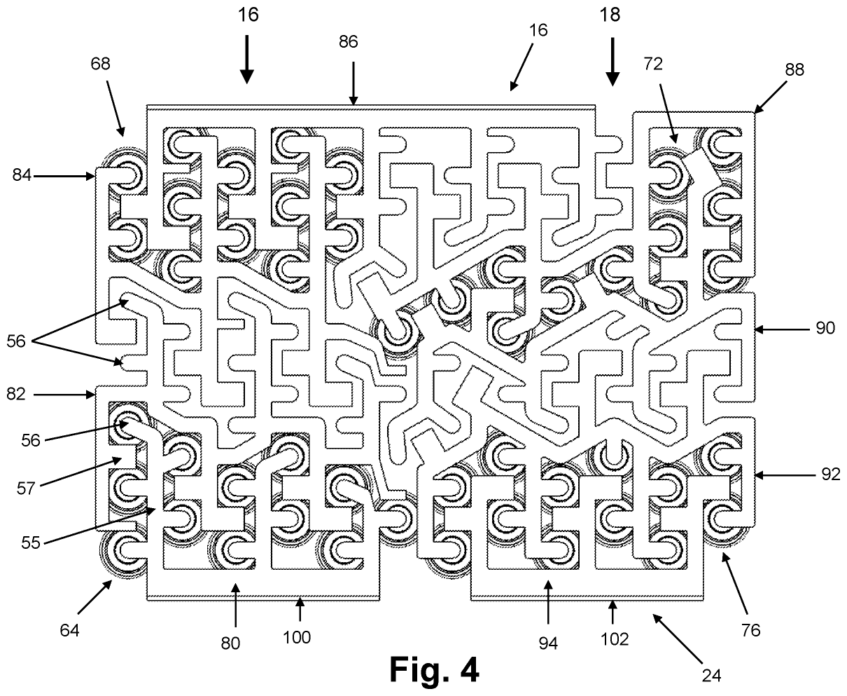

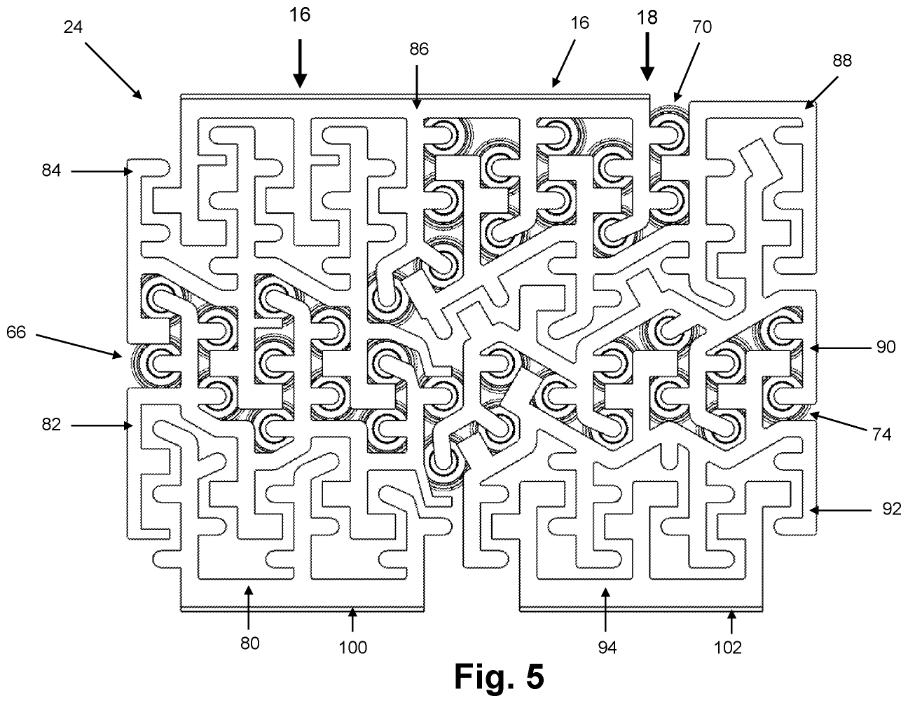

For purposes of better illustration, the second, fourth and sixth groups 66, 70, 74 of battery cells 14 are not shown in FIG. 4, while the first, third, fifth and seventh groups 64, 68, 72, 76 of battery cells 14 are not shown in FIG. 5.

The battery module 10 has a BIS 24 that includes eight monolithic interconnect structures, namely first through eighth interconnect structures 80, 82, 84, 86, 88, 90, 92 and 94, which may be formed by stamping. The eight interconnect structures 80-94 are all disposed in a single layer. The first or positive interconnect structure 80 is the most positive interconnect structure and has a positive terminal 100. The eighth or negative interconnect structure 94 is the most negative interconnect structure and has a negative terminal 102. As shown, the positive and negative terminals 100, 102 are disposed on the same (first) side of the battery module 10, but are located in different module sections, with the positive terminal 100 being located in the first module section 16 and the negative terminal 102 being located in the second module section 18. The first through third interconnect structures 80, 82, 84 are located in the first module section 16 and are disposed over and connected to the first through third battery groups 64, 66, 68, respectively, while the fifth through eighth interconnect structures 88, 90, 92, 94 are located in the second module group 18 and are disposed over and connected to the fourth through seventh battery groups 70, 72, 74, 76. The fourth interconnect structure 86 is partially located in the first module section 16 and partially located in the second module section 18 and is disposed over and connected to the third battery group 68 and the fourth battery group 70. As such, the fourth interconnect structure 86 forms a bridge between the first and second module sections 16, 18 and connects them together. With this construction, current flows from the positive terminal 100, up through the first module section 16, across the bridging fourth interconnect structure 86 and thence down through the second module section 18 to the negative terminal 102. In this manner, current flows in an approximately U-shaped path from the positive terminal 100 to the negative terminal 102. In other words, the direction of electric current flow in the first module section 16 is opposite to the direction of current flow in the second module section 18.

Positive tabs 56 of the first interconnect structure 80 are secured (such as by laser welding) to the positive terminals 52 of the battery cells 14 in the first battery group 64. The negative terminals 54 of the battery cells 14 in the first battery group 64 are secured (such as by laser welding) to negative tabs 57 of the second interconnect structure 82. Positive tabs 56 of the second interconnect structure 82 are secured (such as by laser welding) to the positive terminals 52 of the battery cells 14 in the second battery group 66. The negative terminals 54 of the battery cells 14 in the second battery group 66 are secured (such as by laser welding) to negative tabs 57 of the third interconnect structure 84. This pattern of connection continues through to the securement of the positive tabs 56 of the seventh interconnect structure 92 to the positive terminals 52 of the battery cells 14 in the seventh battery group 76 and the securement of the negative tabs 57 of the eighth interconnect structure 94 to the negative terminals 54 of the battery cells 14 in the seventh battery group 76. In this manner, the first through seventh battery groups 64-76 are connected in series, with the battery cells 14 in each battery group being connected in parallel. Each battery group has a unique configuration of battery cells 14, as described more fully below.

As shown in FIG. 4, the first battery group 64 includes battery cells 14 in six adjacent columns of battery cells 14. From left to right, the six columns contain three, two, two, two, two and one battery cells 14, respectively. The third battery group 68 includes battery cells 14 in five adjacent columns of battery cells 14. From left to right, the five columns contain two, three, two, three and two battery cells 14, respectively. The fifth battery group 72 includes battery cells 14 in seven adjacent columns of battery cells 14. From left to right, the seven columns contain one, one, two, one, one, three and three battery cells 14, respectively. The seventh battery group 72 includes battery cells 14 in six adjacent columns of battery cells 14, with each column containing two battery cells 14.

As shown in FIG. 5, the second battery group 66 includes battery cells 14 in six adjacent columns of battery cells 14. From left to right, the six columns contain two, two, three, two, two and one battery cells 14, respectively. The fourth battery group 70 includes battery cells 14 in six adjacent columns of battery cells 14. From left to right, the six columns contain one, three, two, two, two and two battery cells 14, respectively. The sixth battery group 74 includes battery cells 14 in seven adjacent columns of battery cells 14. From left to right, the seven columns contain one, two, one, two, two, two and two battery cells 14, respectively.

In summary, each interconnect structure 80-94 in the BIS 24 is connected to at least one battery group. More specifically each interconnect structure is connected to two battery groups, except for the first interconnect structure 80 and the eighth (last) interconnect structure 94, which are each only connected to one battery group. In addition, each interconnect structure 80-94 in the BIS 24 is connected to at least one battery cell 14 in each column of at least five adjacent columns of battery cells 14. Also, each interconnect structure 80-94 in the BIS 24 is connected to at least one battery cell 14 in each row of at least four adjacent rows of battery cells 14. Further, each interconnect structure in the BIS 24 has a unique configuration to interconnect with a unique configuration of battery cells 14 in a battery group.

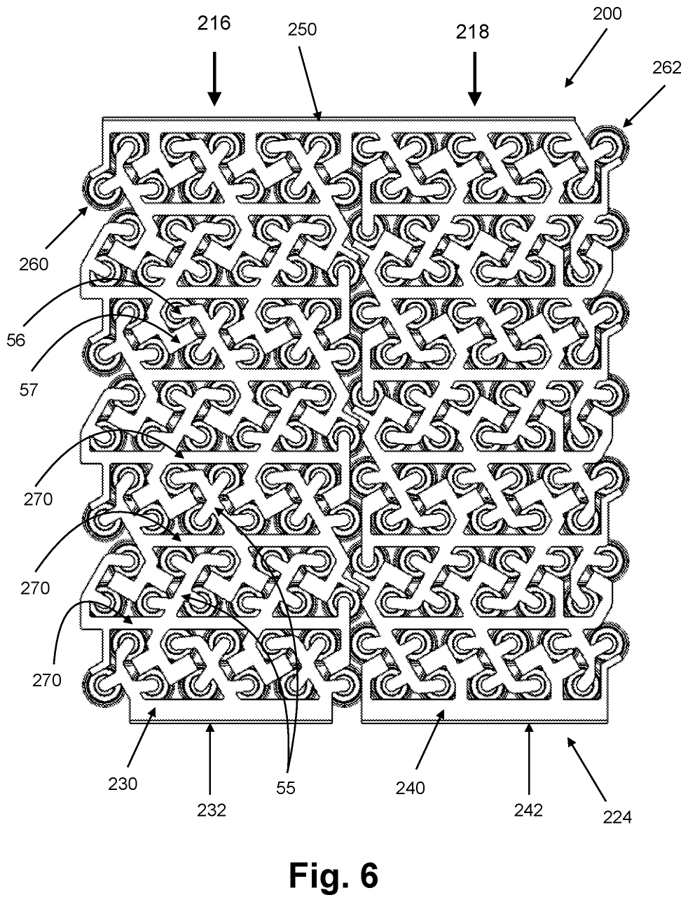

FIG. 6 shows a second battery module 200 constructed in accordance with a second embodiment and having a second BIS 224. The second battery module 200 includes a 14×22 matrix of battery cells 14 having a total of one hundred and fifty-four battery cells 14, with eleven battery cells 14 in each row and seven battery cells 14 in each column. Within the matrix, fourteen groups of battery cells 14 are connected in series and are arranged in adjacent first and second module sections 216, 218, with each of the first and second module sections 216, 218 having seven battery groups. The first and second module sections 216, 218 are arranged side-by-side.

In each battery group, eleven battery cells 14 are connected in parallel. The second BIS 224 has fifteen monolithic interconnect structures arranged in a single layer. A first or positive interconnect structure 230 is the most positive interconnect structure and has a positive terminal 232. A fifteenth or negative interconnect structure 240 is the most negative interconnect structure and has a negative terminal 242. As shown, the positive and negative terminals 232, 242 are disposed on the same (first) side of the second battery module 200, but are located in different module sections, with the positive terminal 232 being located in the first module section 216 and the negative terminal 242 being located in the second module section 218. An eighth interconnect structure 250 acts as a bridge to connect together the first and second module sections 216, 218. More specifically, the eighth interconnect structure 250 connects a seventh battery group 260 in the first module section 216 to an eighth battery group 262 in the second module section 218. As in the first battery module 10, current flows in an approximately U-shaped path from the positive terminal 232 to the negative terminal 242. In other words, the direction of electric current flow in the first module section 216 is opposite to the direction of current flow in the second module section 218.

In the second battery module 200, each group of battery cells 14 includes a portion of a row of battery cells 14 and a portion of an adjacent row of battery cells 14, wherein the number of battery cells 14 in one row is six and the number of battery cells 14 in the adjacent row is five, for a total of eleven battery cells 14. In the first module section 216, each group of battery cells 14 has the same configuration, namely five battery cells 14 in an upper row positioned above six battery cells 14 in a lower row. In the second module section 218, each group of battery cells 14 has the same configuration, namely six battery cells 14 in an upper row positioned above five battery cells 14 in a lower row. The battery groups in the first and second module sections 216, 218 are aligned, namely for each unique pair of upper and lower rows in the matrix, there is a group of battery cells 14 in each of the first and second module sections 216, 218.

A trunk bar 270 of an interconnect structure is disposed between each group of battery cells 14 and extends along portions of two rows of battery cells 14. In each interconnect structure, the arms 55 are joined to and extend from the trunk bar 270. Each interconnect structure in the second BIS 224 is connected to at least one battery group. More specifically each interconnect structure is connected to two battery groups, except for the first interconnect structure 230 and the fifteenth (last) interconnect structure 240, which are each only connected to one battery group.

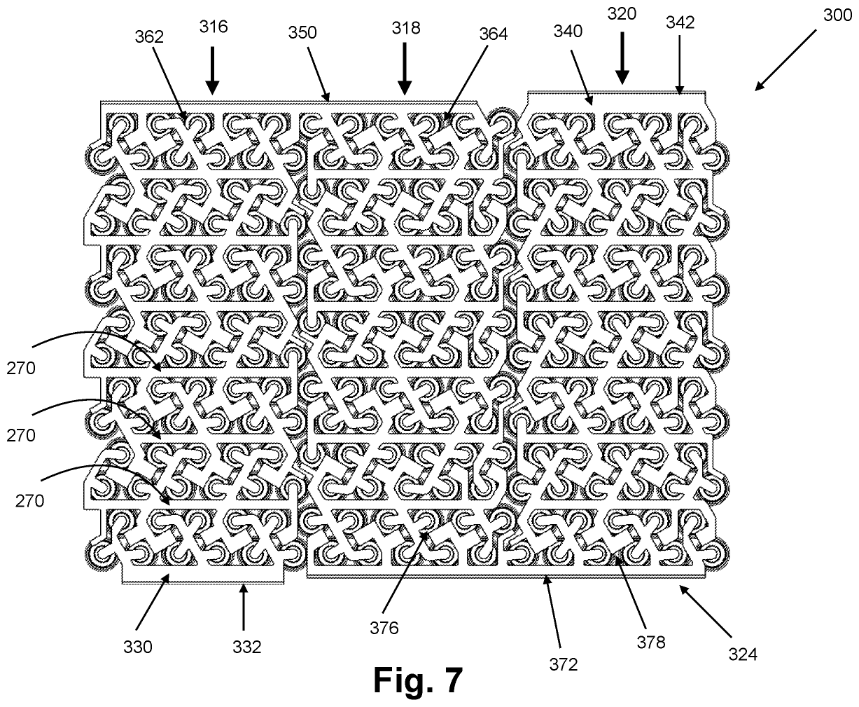

FIG. 7 shows a third battery module 300 constructed in accordance with a third embodiment and having a third BIS 324. The third battery module 300 includes a 14×33 matrix of battery cells 14 having a total of two hundred and thirty-one battery cells 14, with seven battery cells 14 in each column and seventeen battery cells 14 in seven of the rows and sixteen battery cells 14 in seven of the rows. The rows with seventeen battery cells 14 are arranged alternately with the rows with sixteen battery cells 14. Within the matrix, twenty-one groups of battery cells 14 are connected in series and arranged in adjacent first, second and third module sections 316, 318, 320, with seven groups in each module section, wherein each group has eleven battery cells 14 connected in parallel. The first, second and third module sections 316, 318, 320 are arranged side-by-side.

The BIS 324 has twenty-two monolithic interconnect structures arranged in a single layer. A first interconnect structure 330 is the most positive interconnect structure and has a positive terminal 332. A twenty-second interconnect structure 340 is the most negative interconnect structure and has a negative terminal 342. As shown, the positive and negative terminals 332, 342 are disposed on opposite (first and second) sides of the third battery module 300, with the positive terminal 332 being located on the first side in the first module section 316 and the negative terminal 342 being disposed on the second side in the third module section 320. An eighth interconnect structure 350 acts as a bridge to connect together the first and second module sections 316, 318. More specifically, the eighth interconnect structure 350 connects a seventh battery group 362 in the first module section 316 to an eighth battery group 364 in the second module section 318. A fifteenth interconnect structure 372 acts as a bridge to connect together the second and third module sections 318, 320. More specifically, the fifteenth interconnect structure 372 connects a fourteenth battery group 376 in the second module section 318 to a fifteenth battery group 378 in the third module section 320. Current flows in an approximately serpentine path from the positive terminal 332 to the negative terminal 342. More specifically, the current flows upward from the positive terminal 332 to the eighth interconnect structure 350, then over to the second module section 318 and downward to the fifteenth interconnect structure 372 and then over to the third module section 320 and upward to the negative terminal 342. In other words, the direction of electric current flow in the first module section 316 is opposite to the direction of current flow in the second module section 318, but is in the same direction as the current flow in the third module section 320.

In the third battery module 300, each group of battery cells 14 includes a portion of a row of battery cells 14 and a portion of an adjacent row of battery cells 14, wherein the number of battery cells 14 in one row is six and the number of battery cells 14 in the adjacent row is five, for a total of eleven battery cells 14. In the first module section 316, each group of battery cells 14 has the same configuration, namely five battery cells 14 in an upper row positioned above six battery cells 14 in a lower row. In the second module section 318, each group of battery cells 14 has the same configuration, namely six battery cells 14 in an upper row positioned above five battery cells 14 in a lower row. In the third module section 320, each group of battery cells 14 has the same configuration, namely five battery cells 14 in an upper row positioned above six battery cells 14 in a lower row. The battery groups in the first, second and third module sections 316, 318, 320 are aligned, namely for each unique pair of upper and lower rows in the matrix, there is a group of battery cells 14 in each of the first, second and third module sections 316, 318, 320.

A trunk bar 270 of an interconnect structure is disposed between each group of battery cells 14. In each interconnect structure, the arms 55 are joined to and extend from the trunk bar 270. Each interconnect structure is connected to at least one battery group. More specifically each interconnect structure in the third BIS 324 is connected to two battery groups, except for the first interconnect structure 330 and the twenty-second (last) interconnect structure 340, which are each only connected to one battery group.

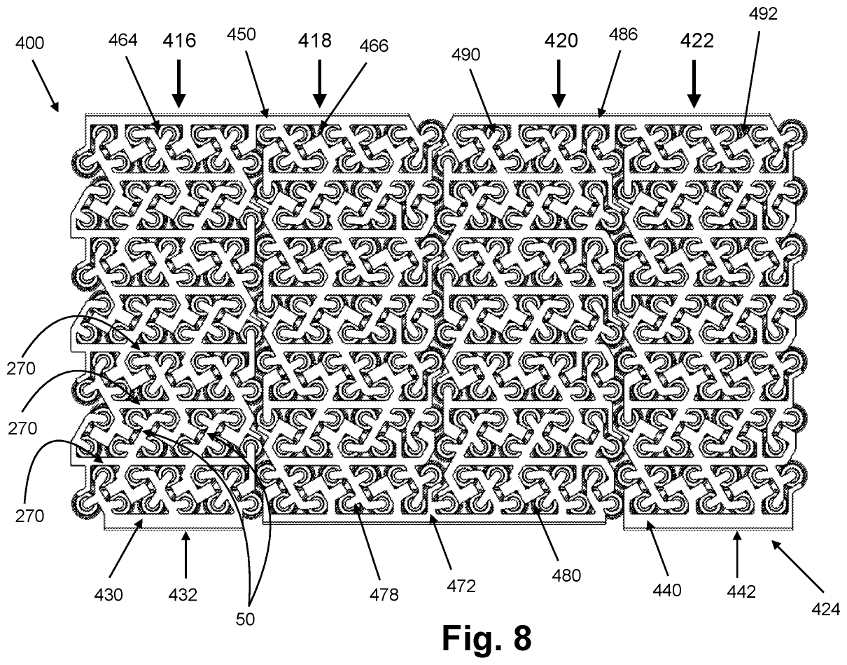

FIG. 8 shows a fourth battery module 400 constructed in accordance with a fourth embodiment and having a fourth BIS 424. The fourth battery module 400 includes a 14×44 matrix of battery cells 14 having a total of three hundred and eight battery cells 14, with seven battery cells 14 in each column and twenty-two battery cells 14 in each row. Within the matrix, twenty-eight groups of battery cells 14 are connected in series and arranged in adjacent first, second, third and fourth module sections 416, 418, 420, 422, with seven groups in each module section, wherein each group has eleven battery cells 14 connected in parallel. The first, second, third and fourth module sections 416, 418, 420, 422 are arranged side-by-side.

The BIS 424 has twenty-nine monolithic interconnect structures arranged in a single layer. A first interconnect structure 430 is the most positive interconnect structure and has a positive terminal 432. A twenty-ninth interconnect structure 440 is the most negative interconnect structure and has a negative terminal 442. As shown, the positive and negative terminals 432, 442 are disposed on the same (first) side of the fourth battery module 400, with the positive terminal 432 being disposed on the first side in the first module section 416 and the negative terminal 442 being disposed on the first side in the fourth module section 422. An eighth interconnect structure 450 acts as a bridge to connect together the first and second module sections 416, 418. More specifically, the eighth interconnect structure 450 connects a seventh battery group 464 in the first module section 416 to an eighth battery group 466 in the second module section 418. A fifteenth interconnect structure 472 acts as a bridge to connect together the second and third module sections 418, 420. More specifically, the fifteenth interconnect structure 472 connects a fourteenth battery group 478 in the second module group 418 to a fifteenth battery group 480 in the third module section 420. A twenty-second interconnect structure 486 acts as a bridge to connect together the third and fourth module sections 420, 422. More specifically, the twenty-second interconnect structure 486 connects a twenty-first battery group 490 in the third module section 420 to a twenty-second battery group 492 in the fourth module section 422. Current flows in approximately serpentine path from the positive terminal 432 to the negative terminal 442. More specifically, the current flows upward from the positive terminal 432 to the eighth interconnect structure 450, then over to the second module section 418 and downward to the fifteenth interconnect structure 472 and then over to the third module section 420 and upward to the twenty-second interconnect structure 486 and then over to the fourth module section 422 and downward to the negative terminal 442.

In the fourth battery module 400, each group of battery cells 14 includes a portion of a row of battery cells 14 and a portion of an adjacent row of battery cells 14, wherein the number of battery cells 14 in one series is six and the number of battery cells 14 in the adjacent series is five, for a total of eleven battery cells 14.

In the first module section 416, each group of battery cells 14 has the same configuration, namely five battery cells 14 in an upper row positioned above six battery cells 14 in a lower row. In the second module section 418, each group of battery cells 14 has the same configuration, namely six battery cells 14 in an upper row positioned above five battery cells 14 in a lower row. In the third module section 420, each group of battery cells 14 has the same configuration, namely five battery cells 14 in an upper row positioned above six battery cells 14 in a lower row. In the fourth module section 422, each group of battery cells 14 has the same configuration, namely six battery cells 14 in an upper row positioned above five battery cells 14 in a lower row. The battery groups in the first, second, third and fourth module sections 416, 418, 420, 422 are aligned, namely for each unique pair of upper and lower rows in the matrix, there is a group of battery cells 14 in each of the first, second and third module sections 416, 418, 420, 422.

A trunk bar 270 of an interconnect structure is disposed between each group of battery cells 14. In each interconnect structure, the arms 55 are joined to and extend from the trunk bar 270. Each interconnect structure in the fourth BIS 424 is connected to at least one battery group. More specifically each interconnect structure is connected to two battery groups, except for the first interconnect structure 430 and the twenty-ninth (last) interconnect structure 440, which are each only connected to one battery group.

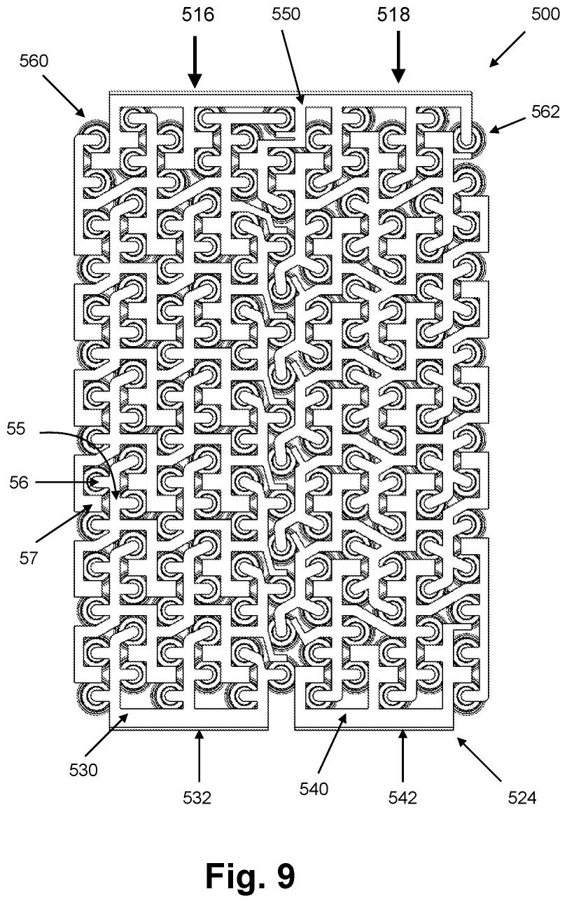

FIGS. 9-11 show a fifth battery module 500 constructed in accordance with a fifth embodiment and having a fifth BIS 524. The fifth battery module 500 includes a 28 X 11 matrix of battery cells 14 having a total of one hundred and fifty-four battery cells 14, with fourteen battery cells 14 in each column and six battery cells 14 in fourteen of the rows and five battery cells 14 in fourteen of the rows. The rows with six battery cells 14 are arranged alternately with the rows with five battery cells 14. Within the matrix, the fifth battery module 500 has fourteen groups of battery cells 14 connected in series and arranged in adjacent first and second module sections 516, 518, with each module section having seven battery groups. In each battery group, eleven battery cells 14 are connected in parallel. The first and second module sections 516, 518 are arranged side-by-side.

The fifth BIS 524 has fifteen monolithic interconnect structures arranged in a single layer. A first or positive interconnect structure 530 is the most positive interconnect structure and has a positive terminal 532. A fifteenth or negative interconnect structure 540 is the most negative interconnect structure and has a negative terminal 542. As shown, the positive and negative terminals 532, 542 are disposed on the same (first) side of the BIS 524, with the positive terminal 532 disposed on the first side in the first module section 516 and the negative terminal 542 disposed on the first side in the second module section 518. An eighth interconnect structure 550 acts as a bridge to connect together the first and second module sections 516, 518. More specifically, the eighth interconnect structure 550 connects together a seventh battery group 560 in the first module section 516 and an eighth battery group 562 in the second module section 518. As in the first battery module 10, current flows in an approximately U-shaped path from the positive terminal 532 to the negative terminal 542. In other words, the direction of electric current flow in the first module section 516 is opposite to the direction of current flow in the second module section 518.

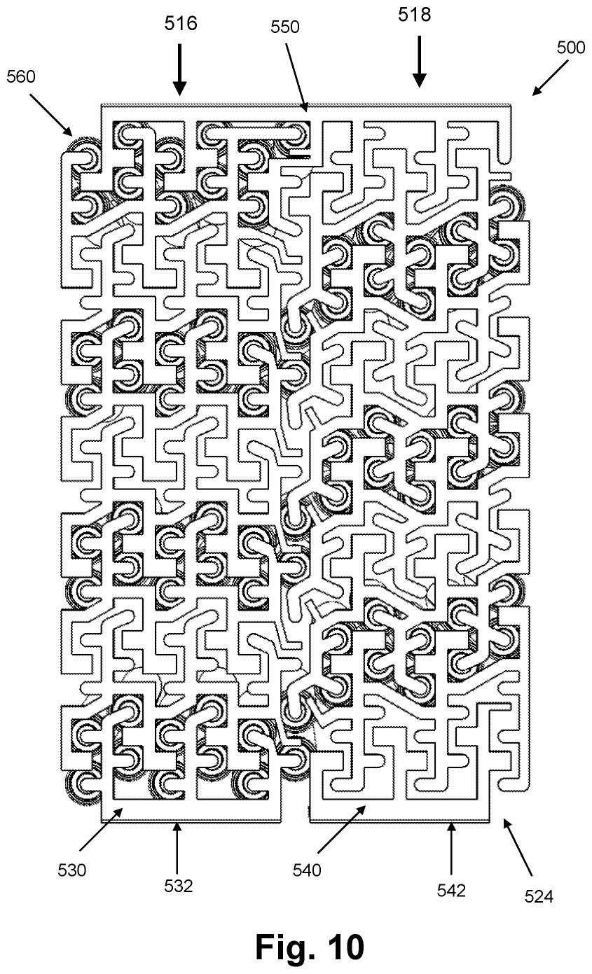

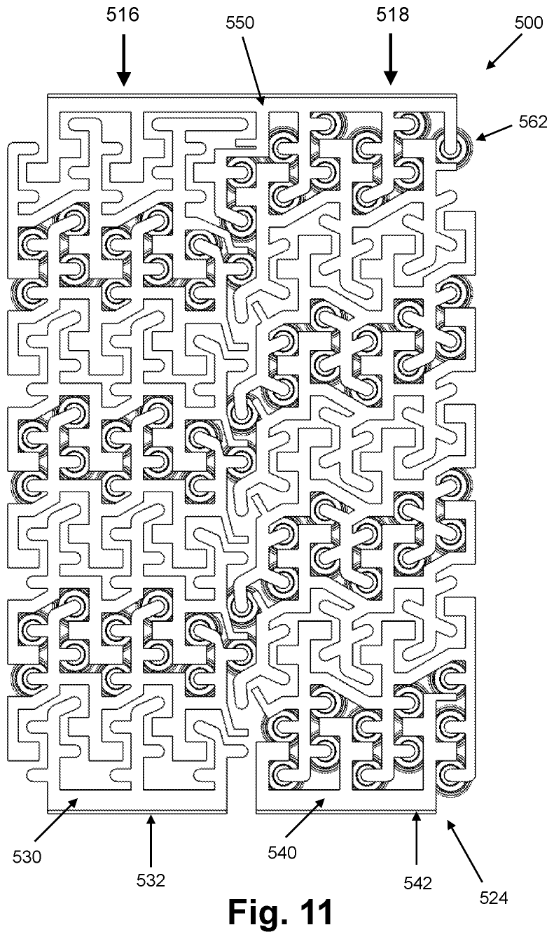

For purposes of better illustration, the second, fourth, sixth, eighth, tenth, twelfth and fourteenth groups of battery cells 14 are not shown in FIG. 10, while the first, third, fifth, seventh, ninth, eleventh and thirteenth groups of battery cells 14 are not shown in FIG. 11. As best shown in FIGS. 10 and 11, each interconnect structure in the fifth BIS 502 is connected to at least one battery group. More specifically, each interconnect structure is connected to two battery groups, except for the first interconnect structure 530 and the fifteenth (last) interconnect structure 540, which are each only connected to one battery group.

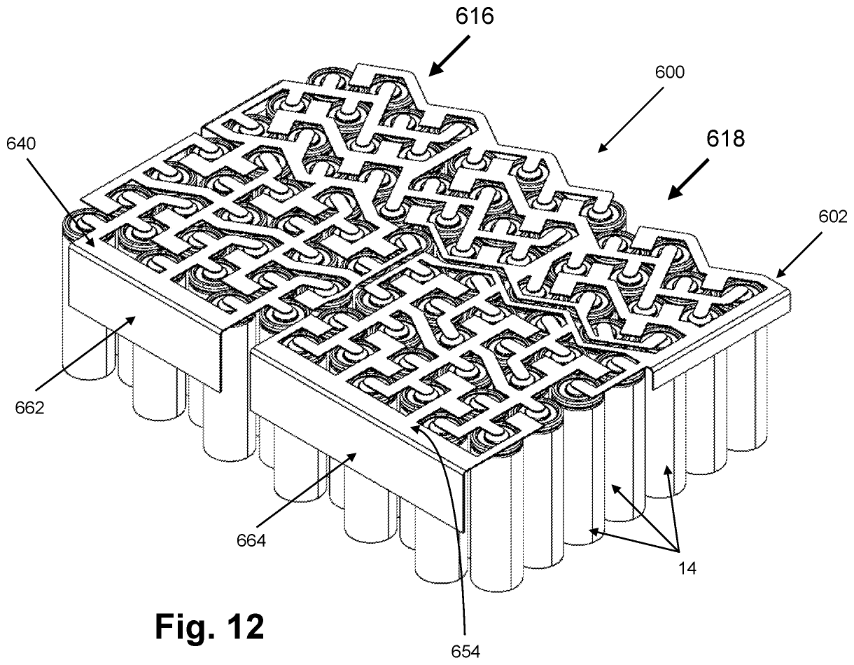

FIGS. 12-14 show a sixth battery module 600 constructed in accordance with a sixth embodiment and having a sixth BIS 602. The sixth battery module 600 includes a 14×12 matrix of battery cells 14 having a total of eighty-four battery cells 14, with six battery cells 14 in each row and seven battery cells 14 in each column. Within the matrix, the sixth battery module 600 has seven groups of battery cells 14 connected in series and arranged in mostly adjacent first and second module sections 616, 618 that are connected together by a bridge that includes a fourth group 626 of battery cells 14 and fourth and fifth interconnect structures 646, 648. The first module section 616 has first, second and third battery groups 620, 622, 624, while the second module section 618 has fifth, sixth and seventh battery groups 628, 630, 632. In each battery group, twelve battery cells 14 are connected in parallel. The first and second module sections 616, 618 are arranged mostly side-by-side, with the fourth battery group 626 separating the battery groups 624, 628 of the first and second module sections 616, 618.

The sixth BIS 602 has eight monolithic interconnect structures 640, 642, 644, 646, 648, 650, 652, 654 arranged in a single layer. A first or positive interconnect structure 640 is the most positive interconnect structure and has a positive terminal 662. An eighth or negative interconnect structure 654 is the most negative interconnect structure and has a negative terminal 664. As shown, the positive and negative terminals 662, 664 are disposed on the same (first) side of the BIS 602, with the positive terminal 662 disposed on the first side in the first module section 616 and the negative terminal 664 disposed on the first side in the second module section 618.

As set forth above, the bridge connects together the first and second module sections 616, 618. More specifically, the fourth and fifth interconnect structures 646, 648 connect the fourth group 626 of battery cells 14 between a third battery group 624 in the first module section 616 and a fifth battery group 628 in the second module section 618. With this construction, current flows from the positive terminal 662, up through the first module section 616, horizontally across the fourth group 626 of battery cells 14 and thence down through the second module section 618 to the negative terminal 664. In this manner, current flows in a channel-shaped path from the positive terminal 662 to the negative terminal 664. Once again, the direction of electric current flow in the first module section 616 is opposite to the direction of current flow in the second module section 618.

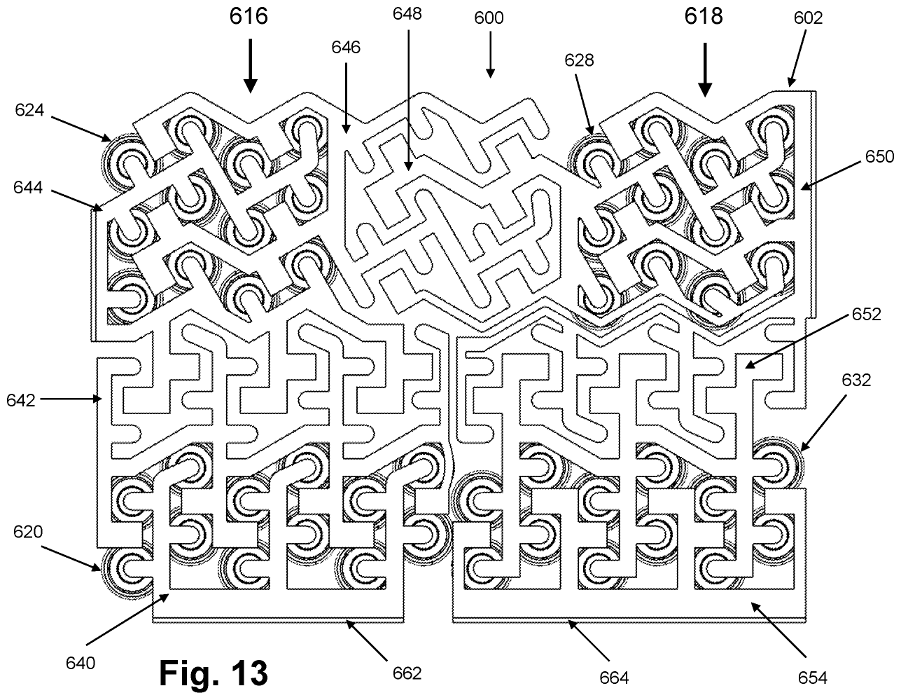

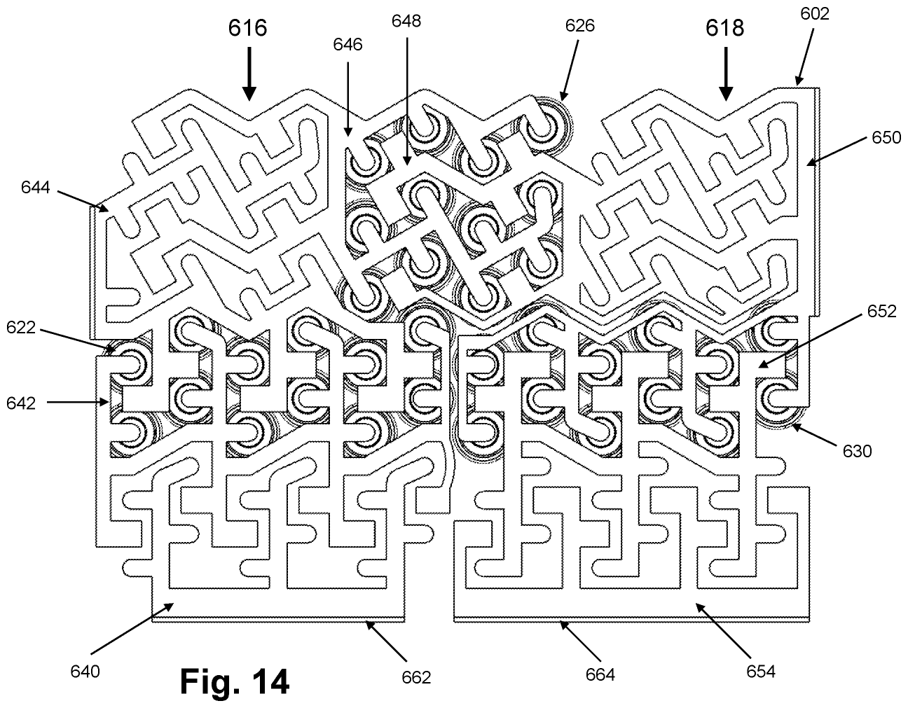

For purposes of better illustration, the second, fourth and sixth groups 622, 626, 640 of battery cells 14 are not shown in FIG. 13, while the first, third, fifth and seventh groups 620, 624, 628 of battery cells 14 are not shown in FIG. 14. As best shown in FIGS. 13 and 14, each interconnect structure in the fifth BIS 602 is connected to at least one battery group. More specifically, each interconnect structure is connected to two battery groups, except for the first interconnect structure 640 and the eighth (last) interconnect structure 654, which are each only connected to one battery group. In each of the battery groups 620, 622, 630, 632 there are three battery cells 14 arranged in each of four adjacent rows of the matrix, with the battery groups 620 and 632 being aligned and the battery groups 622, 630 being aligned. In each of the battery groups 624, 626, 628, there are two battery cells 14 arranged in each of six adjacent rows of the matrix. The battery groups 624, 626, 628 are aligned.

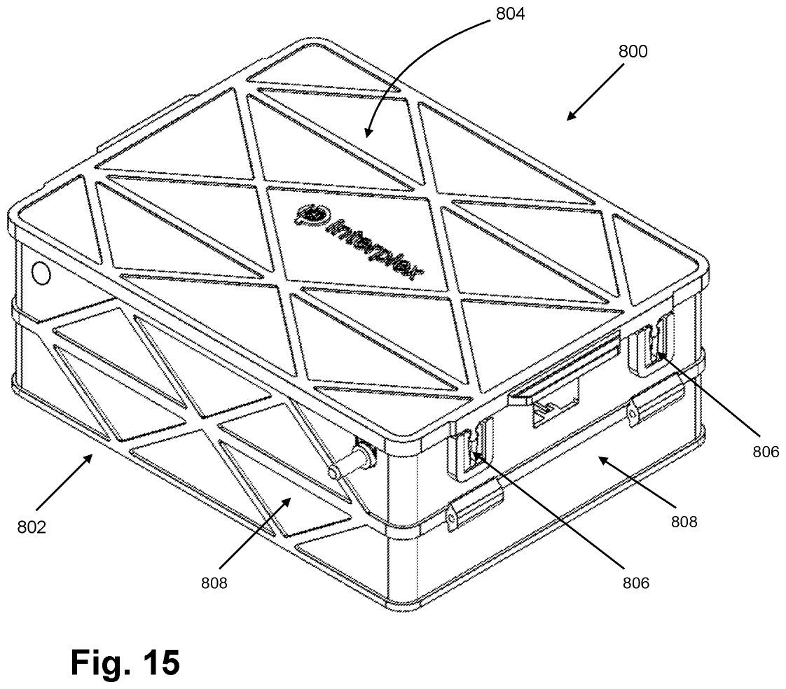

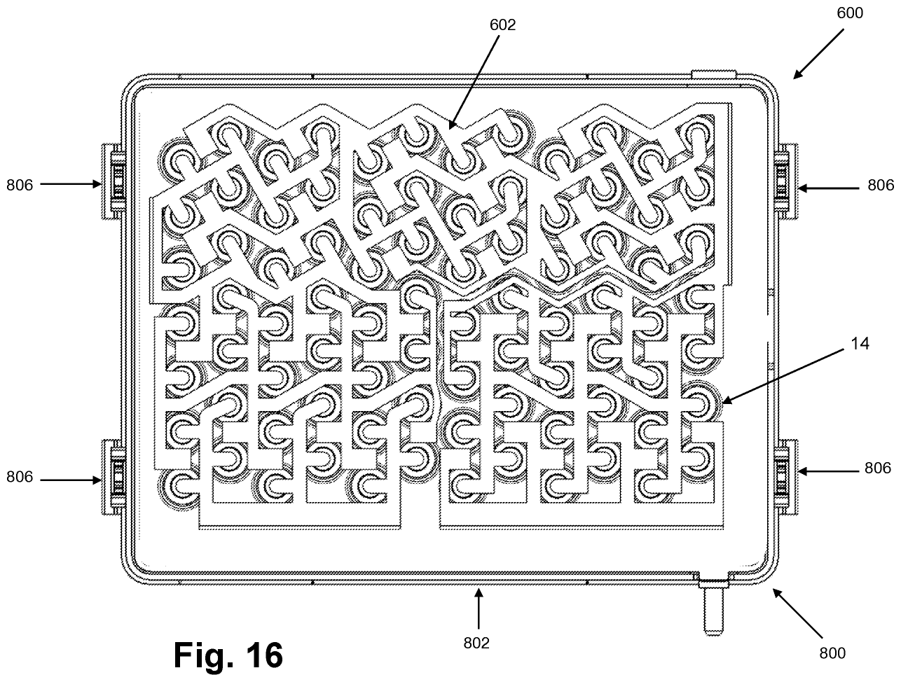

Each of the battery modules described above includes a housing. An example of such a housing (designated by reference numeral 800) is shown in FIG. 15. In FIG. 16, the battery module 600 is shown including the housing 800 with some components removed for better illustration. The housing 800 has a body 802 and a lid 804, one or both of which may be formed from a thermoplastic resin. Preferably, the thermoplastic resin has good electrical insulating properties and is heat resistant. Examples of thermoplastic resins that may be used include polypropylene, polyphenylene ether, polyamide, polyester, polyphenylene sulfide, liquid crystal polymer, polystyrene, polycarbonate and polybutylene terephthalate. The body 802 and the lid 804 may each be constructed to have components of latch structures 806 that secure the lid 804 to the body 802 to form a seal therebetween, whereby the interior of the body 802 is sealed from the outside environment. The body 802 includes a plurality of exterior walls 808. An opposing pair of the exterior walls 808 may include projections for receipt in mounting rails, which are used to mount a plurality of battery modules to a structure, such as a chassis of a vehicle.

The housing body 802 may be generally cuboidal in shape and defines an interior holding space for holding the battery cells 14, which are connected together by the BIS. One or more cell holders are disposed in the interior holding space of the housing body and hold(s) the battery cells 14. Each cell holder may be composed of plastic and includes a substrate having a plurality of openings extending therethrough. Each opening snugly holds one of the battery cells 14 and, as such, may be formed by an interior surface of the substrate that has a configuration corresponding to the exterior configuration of a battery cell 14. Thus, if the battery cells 14 are cylindrical (such as shown), the openings may be circular. Upper and lower cell holders may be provided, with the upper cell holder retaining upper portions of the battery cells 14 and the lower cell holder retaining lower portions of the battery cells 14. One or both of the upper and lower cell holders may be integrally joined to the housing body 802 so as to form a unitary or monolithic structure therewith. For example, the lower cell holder may be part of a bottom wall of the housing body 802. In some embodiments, only a single cell holder may be provided.

It is to be understood that the description of the foregoing exemplary embodiment(s) is (are) intended to be only illustrative, rather than exhaustive. Those of ordinary skill will be able to make certain additions, deletions, and/or modifications to the embodiment(s) of the disclosed subject matter without departing from the spirit of the disclosure or its scope.

1. A battery module comprising:
a plurality of battery cells, each of the battery cells comprising a positive terminal and a negative terminal, the battery cells being arranged in groups, which are located in at least two module sections; and
a plurality of monolithic interconnect structures connected to the battery cells, the interconnect structures are formed from a conductive metal and comprise a plurality of positive tabs connected to the positive terminals of the battery cells and a plurality of negative tabs connected to the negative terminals of the battery cells, the interconnect structures being connected to the battery cells to have electrical current flow in a first direction in one of the module sections and flow in an opposing second direction in another one of the module sections; and
wherein the interconnect structures are arranged in a single layer.

2. The battery module of claim 1, wherein each group of battery cells comprises four or more battery cells that are connected together in parallel by a pair of the interconnect structures; and
wherein the groups of battery cells are connected in series by the interconnect structures.

3. The battery module of claim 2, wherein the battery cells are arranged in a matrix having ten or more rows and ten or more columns of battery cells; and
wherein the module sections are disposed at least partially side-by-side and wherein each module section comprises at least three groups of battery cells.

4. The battery module of claim 3, wherein each group of battery cells has at least one battery cell in each of four rows of battery cells.

5. The battery module of claim 3, wherein each group of battery cells has at least five battery cells in each of two rows of battery cells.

6. The battery module of claim 3, wherein each group of battery cells has at least eleven battery cells connected together in parallel.

7. The battery module of claim 3, wherein the number of interconnect structures is greater than the number of groups of battery cells.

8. The battery module of claim 1 further comprising a housing having a body closed by a lid, the body containing the battery cells and the interconnect structures.

9. The battery module of claim 1, wherein the interconnect structures comprise a plurality of trunk bars, and wherein in each group of battery cells, a trunk bar is connected to and extends along at least a portion of a row of battery cells.

10. The battery module of claim 9, wherein in each group of battery cells, the trunk bar is connected to and extends along at least five adjacent battery cells.

11. The battery module of claim 10, wherein each trunk bar is connected to a plurality of the negative terminals or a plurality of the positive terminals of the at least five adjacent battery cells.

12. The battery module of claim 1, wherein each group of battery cells comprises at least four battery cells, wherein each module section comprises at least three groups of battery cells, and wherein the module sections are disposed side-by-side.

13. The battery module of claim 12, wherein the battery module comprises first, second and third module sections, with the second module section being disposed between the first module section and the third module section, and wherein current flows in the first direction in the first module section and the third module sections section and flows in the opposing second direction in the second module section.

14. (canceled).

15. The battery module of claim 13, wherein the battery module further comprises a fourth module section disposed adjacent to the third module section such that the third module section is disposed between the second module section and the fourth module section, and wherein current flows in the first direction in the first module section and the third module section and flows in the opposing second direction in the second module section and the fourth module sections section.

16. The battery module of claim 1, further comprising positive and negative terminals connected to different ones of the module sections.

17. The battery module of claim 16, wherein the positive terminal is integral with a first one of the interconnect structures and the negative terminal is integral with a final one of the interconnect structures;
wherein the first one of the interconnect structures has only positive tabs connected to positive terminals of battery cells;
wherein the final one of the interconnect structures has only negative tabs connected to negative terminals of battery cells; and
wherein other ones of the interconnect structures each have positive tabs connected to positive terminals of battery cells and negative tabs connected to negative terminals of battery cells.

18. The battery module of claim 17, wherein the positive and negative terminals are located on the same side of the battery module.

19. The battery module of claim 16, wherein electric current flows in an approximately serpentine path from the positive terminal to the negative terminal.

20. The battery module of claim 16, wherein electric current flows in a channel-shaped path from the positive terminal to the negative terminal.

21. The battery module of claim 1, wherein the conductive metal of the interconnect structures comprises copper or a copper alloy, and wherein the interconnect structures are formed by stamping.
